(19) United States
(12) Patent Application Publication
(10) Pub. No.: US 2007/0259607 A1
(43) Pub. Date: Nov. 8, 2007

(54) METHOD AND CUTTING AND LAPPING A WORKPIECE

(75) Inventor: Wolfgang Dietz, Dresden (DE)

Correspondence Address: BROOKS KUSHMAN P.C., 1000 TOWN CENTER, TWENTY-SECOND FLOOR, SOUTHFIELD, MI, 48075, US

(73) Assignee: Siltronic AG, Munich (DE)

(21) Appl. No.: 11/739,710

(22) Filed: Apr. 25, 2007

(30) Foreign Application Priority Data
May 4, 2006 (DE) 10 2006 020 824.2

(51) Int. Cl. B28D 1/06; B24B 7/30

(52) U.S. Cl. 451/41; 125/16.02

(57) ABSTRACT

Cutting and lapping of a workpiece such that the workpiece is divided into thin wafers with the aid of a lapping compound and a circulating wire tool bringing the lapping compound into engagement is improved by employing a wire cable as the wire tool.

### BACKGROUND OF THE INVENTION

1. Field of the Invention

The subject matter of the invention is a method of cutting and lapping a workpiece, the workpiece being divided into thin wafers with the aid of a lapping compound and a circulating wire tool bringing the lapping compound into engagement.

2. Background Art

Devices for the cutting and lapping of workpieces are usually known as multiwire saws, because they use a thin sawing wire for the cutting operation, running at a certain speed around an array of deflecting rollers around which it is multiply wound. The wire loops produced by the winding form a gang of wire portions arranged in parallel, through which the workpiece is passed while a lapping compound is supplied. As this happens, the axially moving wire portions transport the lapping compound, which contains loose lapping grain, to the point of action. The interaction between the wire and the lapping compound, the material to be machined and the chosen machining kinematics, creates a lapping gap in which the actual machining process takes place. Since the gang of wires is formed by a multiplicity of wire portions arranged equally spaced apart next to one another, at the same time a multiplicity of thin wafers are also produced when the wire portions leave the workpiece again. The method is therefore often used when large numbers of thin wafers have to be produced with high precision. This is the case for example in the semiconductor industry. There, wafers are cut from monocrystalline or polycrystalline semiconductor material and further processed, for example into electronic components and solar cells.

After being cut off, the wafers must have side faces that are as planar as possible and lie as parallel to each other as possible. Since the wire portions usually move in the same axial direction, freshly supplied lapping compound is transported with preference first to where the wire portions enter the lapping gap. Up to the point where it leaves the lapping gap, the lapping grain is subjected to a certain degree of wear, which primarily affects the larger particles in the lapping compound. This has the consequence that the wafers are given a wedge-like form, because the lapping gap is increasingly reduced between the entry and the exit of the wire portions and the thickness of the wafers increases correspondingly.

Solutions aimed at a more efficient distribution of the lapping compound in the lapping gap have already been proposed. According to EP 953416 A2, supplying the lapping gap with the lapping compound can be improved by the workpiece performing a rocking motion during the cutting operation, shortening the length of engagement of the wire portions. The method described in US Pat. No. 6,554,686 uses a torsionally stressed sawing wire for the same purpose, which turns in the lapping gap and in this way distributes the lapping compound more effectively.

### SUMMARY OF THE INVENTION

The object of the present invention is to provide an improved method by which the transport of the lapping compound to the point of action is facilitated and, as a result, an increased machining performance and improved geometry on the cut workpiece is made possible. These and other objects are surprisingly achieved through the use of a wire cable as opposed to a single wire as has been used in the past.

### BRIEF DESCRIPTION OF THE DRAWINGS

FIG. 1 illustrates one embodiment of the subject invention.

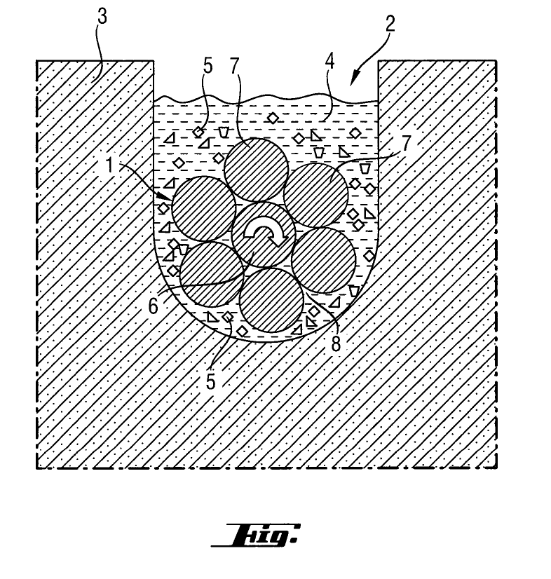

### DETAILED DESCRIPTION OF THE PREFERRED EMBODIMENT(S)

The subject matter of the invention is a method of cutting and lapping a workpiece, the workpiece being divided into thin wafers with the aid of a lapping compound, a circulating wire tool bringing the lapping compound into engagement, which method is characterized by the use of a wire cable as the wire tool.

Wire cables have not previously been used as wire tools for cutting and lapping, but merely in wire saws for concrete or stoneware, together with saw teeth mounted on the wire cable. Such a wire cable is known for example from U.S. Pat. No. 6,283,112 or DE 25 45 347 A1.

The present invention uses the surface structure of a wire cable which comprises a number of individual wire strands. The surface structure is distinguished by channels which run spirally around the wire cable and are used for transporting the lapping compound in the lapping gap, and consequently improving the distribution thereof. In addition, the wire cable has the advantage that the improved lapping compound transport means that greater machining performance is achieved, which in turn increases the yield. Since a wire cable achieves only a slightly lower tensile strength in comparison with single wire, it is possible to operate with a comparable lapping pressure as would be used with single strand wires. A further advantage of the method is that a wire cable has greater flexibility than a single wire of the same diameter, and consequently performs better when it is deflected over guiding rollers. A possible tear of an individual wire of the wire cable can be easily detected by means of a separate device and corresponds to the procedure for dealing with a wire tear in the method of wire sawing.

It is preferred within the scope of the invention to use a wire cable which comprises a strand, with a single wire as the strand core and individual wires twisted around the strand core, the number of individual wires twisted around the strand core preferably being 4 to 8, with particular preference 6. In addition, other cable constructions can likewise be used. The diameter of the wire cable, that is to say the diameter of a circle enclosing the wire cable, is preferably 50 to 500 μm, with particular preference 100 to 200 μm. The individual wires preferably consist of steel.

Furthermore, it is preferred within the scope of the invention to additionally perform one or more further measures to improve the distribution of the lapping compound in the lapping gap. These measures include subjecting the workpiece to a rocking motion, which shortens a length of engagement of the wire tool, periodically reversing the direction of movement of the circulating wire tool and turning the wire cable about its longitudinal axis.

The lapping compound is a suspension which contains lapping grain with a certain size distribution of the grains, a liquid and optionally additives. Hard materials such as silicon carbide, boron carbide and diamond are particularly suitable as lapping grain. The liquid is, for example, water, glycol, a glycol-water mixture or an oil.

The method is suitable in particular for cutting off thin semiconductor wafers from monocrystalline or polycrystalline workpieces of a semiconductor material, such as for example silicon, silicon carbide and gallium arsenide, in particular for cutting off semiconductor wafers of monocrystalline or polycrystalline silicon from single crystals or from blocks. Depending on the intended purpose for which they are to be used, the thickness of the cut-off semiconductor wafers is 200 to 2000 μm.

A preferred embodiment of the invention is represented in the figure, which shows, in a sectional representation a wire portion, a wire cable 1, at a point in time at which a lapping gap 2 which already reaches deep into the workpiece 3 has been created. The lapping compound 4 with lapping grain 5 slurried in liquid is located together with the wire cable portion in the lapping gap 2. The wire cable 1 comprises a strand with a single wire as the strand core 6 and six further outer individual wires 7, twisted, that it is to say wound, around the single wire. Formed between these outer individual wires are channels 8, which facilitate the transport and distribution of the lapping compound in the lapping gap.

The rotation of the cable about the longitudinal axis may be brought about on the one hand by deflecting on the cable guiding rollers in the form of autorotation and on the other hand by the pretensioning according to U.S. Pat. No. 6,554,686.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. In a method of cutting and lapping a workpiece, the workpiece being divided into thin wafers with the aid of a lapping compound, a circulating wire tool having a longitudinal axis bringing the lapping compound into engagement, the improvement comprising cutting with a wire cable as the wire tool.

2. The method of claim 1, wherein a wire cable with a diameter of 50 to 500 μm is used as the wire tool.

3. The method of claim 1, wherein a wire cable with a diameter of 100 to 200 μm is used as the wire tool.

4. The method of claim 1, wherein a wire cable which comprises a strand with a single wire as the strand core and individual wires twisted around the strand core is employed as the wire tool.

5. The method of claim 2, wherein a wire cable which comprises a strand with a single wire as the strand core and individual wires twisted around the strand core is employed as the wire tool.

6. The method of claim 1, wherein the workpiece is subjected to a rocking motion which is effective to shorten a length of engagement of the wire tool with the workpiece until wafers are separated therefrom.

8. The method of claim 1, wherein the direction of movement of the circulating wire tool is periodically reversed.

9. The method of claim 1, wherein the wire tool is rotated about its longitudinal axis.
